(19) United States
(12) Patent Application Publication
(10) Pub. No.: US 2026/0277915 A1
(43) Pub. Date: Sep. 17, 2026

(54) WEIGHTED MULTICATEGORY QUERYING

(71) Applicant: Microsoft Technology Licensing, LLC, Redmond, WA (US)

(72) Inventors: Ge WANG, Sammamish, WA (US); Pak On CHAN, Seattle, WA (US); Deepika PURI, Syosset, NY (US); Andy NGUYEN, Seattle, WA (US); Vinayak NADIR, New Delhi (IN); Ghazal MAZAHERI, Santa Monica, CA (US); Ravi Kiran REDDY POLURI, Seattle, WA (US); Milenko DRINIC, Kenmore, WA (US); Rajesh CHILLAKURU, Everett, WA (US); Samuel Johnson SHELTON, Kirkland, WA (US); Sundar KAMESWARAN, Redmond, WA (US); Nicholas James ROBINSON, Redmond, WA (US); Ramya KONERU, San Jose, CA (US); Annapurna Lakshmi SARIPALLI, Hyderabad (IN); Chen XU, Lynnwood, WA (US); Amitesh JAIN, Redmond, WA (US); Kai LIANG, Bellevue, WA (US); Pankaj Jitendra PARIKH, Snohomish, WA (US); Michael RAWSON, Seattle, WA (US); Maxim NACU, Redmond, WA (US); Venkata Rao SALADI, Redmond, WA (US)

(21) Appl. No.: 19/194,113

(22) Filed: Apr. 30, 2025

(30) Foreign Application Priority Data
Mar. 13, 2025 (IN) 202511022923

(51) Int. Cl. G06F 16/2457; G06F 16/242; G06F 16/248

(52) U.S. Cl. CPC G06F 16/24578; G06F 16/242; G06F 16/248

(57) ABSTRACT

A weighted multicategory querying (WMQ) tool generates alternates of an initial query through spelling correction, grammar correction, natural language processing, ambiguous term resolution, term normalization, keyword reordering, synonyms, and similar terms. The WMQ tool generates additional queries in different weighted categories such as keyword combination, query programming language (QPL), metadata, or embedding space. Query result individual topic proximity scores are combined with category weights to calculate a combined topic proximity score, which is employed to rank the query result. Embedding space query weight is increased for queries classified as broad. QPL query weight or metadata query weight is increased for queries which contain part or all of a metadata field name. Language models are leveraged for query generation, topic proximity scoring, or both.

### RELATED APPLICATION

The present application claims priority to, and incorporates by reference the entirety of, India provisional patent application number 202511022923 filed 13 Mar. 2025.

### BACKGROUND

In computing, text processing supports or performs operations which analyze, categorize, create, edit, filter, format, generate a report, search, search and replace, simplify, summarize, or translate, or other operations. The text being processed often includes natural language text, but in some scenarios the text also or instead includes programming language source code or other artificial language text. Text processing as understood herein includes, but is not limited to, computational operations with text in scenarios including databases, artificial intelligence mechanisms, natural language processing, or combinations thereof.

### SUMMARY

Some weighted multicategory query embodiments taught herein address technical challenges arising from fragmented and inconsistent search efforts. One challenge is how to improve search efficiency when conducting comprehensive searches of a corpus of documents. Another challenge is how to improve search effectiveness without increasing search tool user interface complexity. Other technical challenges of querying large bodies of text are also addressed herein.

One example embodiment of weighted multicategory querying taught herein generates queries which belong to different respective categories, e.g., a keyword combination category, a query programming language category, or an embedding space category. This embodiment associates respective weights with the generated queries, issues at least two queries, and receives query results. The query results are scored for topic proximity. The embodiment calculates a query result combined topic proximity score from the query result topic proximity scores and the weights, and provides the query result and the query result combined topic proximity score to a results ranker. This embodiment enhances search efficiency by selectively bypassing queries with lower assigned weights for a particular query category, or selectively ranking the query results lower, or both. This embodiment improves search effectiveness through a multicategory approach which helps ensure that both precise keyword matches and broader conceptual connections are captured, enhancing the overall scope and topic proximity of the search.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description is given with reference to the attached drawings. These drawings only illustrate selected aspects and thus do not fully determine coverage or scope.

FIG. 1 is a diagram illustrating aspects of computer systems, including some aspects generally suitable for enhanced systems which include or use weighted multicategory querying (WMQ) functionality;

FIG. 2 is a block diagram illustrating aspects of a first example family of enhanced systems which are each configured with WMQ functionality;

FIG. 3 is a dataflow diagram of a second example family of enhanced systems which are each configured with WMQ functionality;

FIG. 4 is an architecture diagram of a third example family of enhanced systems which are each configured with WMQ functionality;

FIG. 5 is a block diagram illustrating some aspects and items related to querying;

FIG. 6 is a first flowchart illustrating some WMQ methods;

FIG. 7 is a second flowchart illustrating some WMQ methods;

FIG. 8 is a third flowchart illustrating some WMQ methods;

FIG. 9 is a fourth flowchart illustrating some WMQ methods;

FIG. 10 is a fifth flowchart illustrating some WMQ methods; and

FIG. 11 is a sixth flowchart further illustrating WMQ methods, and incorporating as options the steps of each of FIG. 6 through FIG. 10, and other steps disclosed herein.

### DETAILED DESCRIPTION

### Overview

Some teachings described herein reflect technical challenges faced and insights gained during efforts to improve search tools or categorization tools. However, the teachings herein are not limited in their scope or applicability to this particular kind of software, or to these particular challenges, solutions, or insights, or to the particular application fields used as examples.

In some fields, one approach to the problem of finding documents that pertain to a particular subject is to apply indexing technology like the kind that enables web searches. Web search engines use indexes produced by programs called crawlers or spiders. The indexes contain data about keywords and their locations in web pages, allowing the search engine to retrieve search results containing keywords. But a disadvantage of keyword-based search is that the indexes rely on a list of keywords to match against the web page content through string comparison, so semantically related words and their surrounding content are not necessarily included in search results. For example, when the list of keywords includes “horse” but does not include “foal”, “Secretariat”, “thoroughbred”, “Appaloosa”, or “mule”, content that includes any of the latter words but does not include “horse” will not be retrieved by a keyword search.

Another approach to the problem of finding documents that pertain to a particular subject is to apply vector embedding technology. Words or phrases are vectorized, such that semantically similar words or phrases correspond to nearby vectors in a vector space under cosine similarity or another metric. For example, an embedding vector for “horse” would be closer to embedding vectors for “foal”, “Secretariat”, “thoroughbred”, “Appaloosa”, and “mule” than it would be to an embedding vector for “quantum computer”. Content that is semantically related to “horse” can thus be retrieved even when that content does not contain the word “horse” itself. However, generating and comparing the embedding vectors requires significantly more computational power than string comparison, and nearby vectors do not necessarily give accurate results, e.g., in scenarios involving product names or jargon. The values given to embedding vectors depend heavily on the particular training data that is processed to create those vectors. Understanding why a particular result was returned by a vector-based search is also less clear in many cases than with keyword-based search results.

Some embodiments described herein take a different approach, referred to herein as weighted multicategory querying (WMQ). WMQ is also referred to as weighted multiform querying. From a given query, WMQ embodiments generate multiple queries which belong to different respective categories, e.g., both a keyword combination category and an embedding space category. In some scenarios, other categories are also or instead employed, including a query programming language category or a metadata category. An embodiment associates respective weights with the generated queries, issues at least two queries, and receives query results as a result of issuing the queries. The query results are scored for topic proximity. The embodiment calculates a query result combined topic proximity score from the query result topic proximity scores and the weights, and provides the query result and the query result combined topic proximity score to a results ranker.

Some WMQ embodiments described herein utilize or provide a WMQ method performed by a computing system. This WMQ method includes: generating a first query from a base query, the first query belonging to a first query category; generating a second query from the base query, the second query belonging to a second query category which differs from the first query category, each of the first query category and the second query category including at least one of: a keyword combination category, a query programming language category, or an embedding space category; associating a first query weight with the first query; associating a second query weight with the second query; issuing the first query and in response receiving a query result and receiving a first query result topic proximity score; issuing the second query and in response receiving the query result and receiving a second query result topic proximity score; calculating a query result combined topic proximity score from at least the first query result topic proximity score, the first query weight, the second query result topic proximity score, and the second query weight; and providing the query result and the query result combined topic proximity score to a results ranker. Notice that a/the “query result” is received in response to both the first query and the second query. This does not require fully identical results from the two queries, but it does mean the results overlap. That is, the “query result” is in an intersection of the data resulting from the first query and the data resulting from the second query.

This WMQ functionality has a technical benefit of improving search effectiveness relative to a scenario which lacks this functionality, by capturing both precise keyword matches and broader conceptual connections, when the queries issued are in the keyword combination category and the embedding space category. This capability enhances the overall scope and topic proximity of the search without imposing additional burdens on users to personally perform multiple searches and coordinate the search results. This WMQ functionality also has a technical benefit of improving search tool usability in the sense that user input operations are facilitated because the user receives results of a multicategory query process from a relatively simple input query.

In some WMQ embodiments, the first query belongs to the query programming language category; generating the first query from the base query includes detecting a metadata field name in the base query; and in response to the detecting, the method includes increasing the first query weight relative to the second query weight. The increase is relative in that it can be accomplished by increasing a first value which is stored as the first query weight, by decreasing a second value which is stored as the second query weight, or both.

This WMQ functionality has a technical benefit of increasing search result accuracy, relative to a scenario which lacks this functionality. When a user's query suggests specific metadata topic proximity (e.g., an author, a date, or a document type), these embodiments construct a query programming language (QPL) query that targets the corresponding metadata fields, enabling structured filtering within metadata. Specifically, the QPL query targets metadata by field name, and in some cases also by a limitation on the metadata field value. Results of the metadata-targeting query are prioritized for surfacing in the overall search results, by the increased query weight placed on the QPL query.

In some WMQ embodiments, the first query belongs to the embedding space category; generating the first query from the base query includes classifying the base query as a broad query; and in response to the classifying, the method includes increasing the first query weight relative to the second query weight.

This WMQ functionality has a technical benefit of increasing search effectiveness without sacrificing the accuracy of keyword searches or the accuracy of metadata searches. When a user's query is classified as broad, these embodiments construct an embedding space query that targets vectors within a specified distance of vector(s) which correspond to the broad query, thus enabling retrieval of semantically related results even when metadata field names or other keywords are not matched through string comparison. Results of the embedding space query are prioritized for surfacing in the overall search results, by the increased query weight placed on the embedding space query.

In some WMQ embodiments, generating the first query or generating the second query or both includes performing at least one of: an ambiguous term resolution; a term normalization; a change in an order of keywords; or a replacement of a particular word by a synonym of the particular word.

This WMQ functionality has a technical benefit of improving search effectiveness by resolving ambiguities and by normalizing terminology within the query input from the user, thus helping to ensure an accurate interpretation of the user's input which reduces machine operations, e.g., CPU cycles to get to a result, user interface processing, network communications, database accesses, security risks, etc. This WMQ functionality also improves search effectiveness by expanding the scope of the search to semantically related results without necessarily incurring the computational costs of an embedding space search, through use of additional queries that include a change in the order of keywords or replacement of a particular word by a synonym.

In some WMQ embodiments, a query issuer includes instructions which upon execution by a processor skip issuing a query in a particular category in response to a determination that the weight corresponding to that particular category is below a query issuance threshold.

This WMQ functionality has a technical benefit of enhancing search efficiency by selectively bypassing queries with lower assigned weights for specific query alteration forms. Instead of issuing these less proximate queries, the embodiment merges the results from prioritized (greater weight) data sources, optimizing performance and reducing unnecessary processing.

In some WMQ embodiments, the WMQ method includes: submitting to a language model a prompt to perform at least one of: generating the first query, or generating the second query; and receiving the first query or the second query or both, in response to at least the prompt.

This WMQ functionality has a technical benefit of improving accuracy and effectiveness by leveraging language model capabilities to correct spelling, resolve ambiguities, or normalize terminology within the query input by the user, thus helping to ensure a correct interpretation of the user's input. Incorrect interpretation of the user's input tends to produce inaccurate results, which tend to make the query tool less effective.

These and other advantages and benefits will be apparent to one of skill from the teachings provided herein.

### Operating Environments

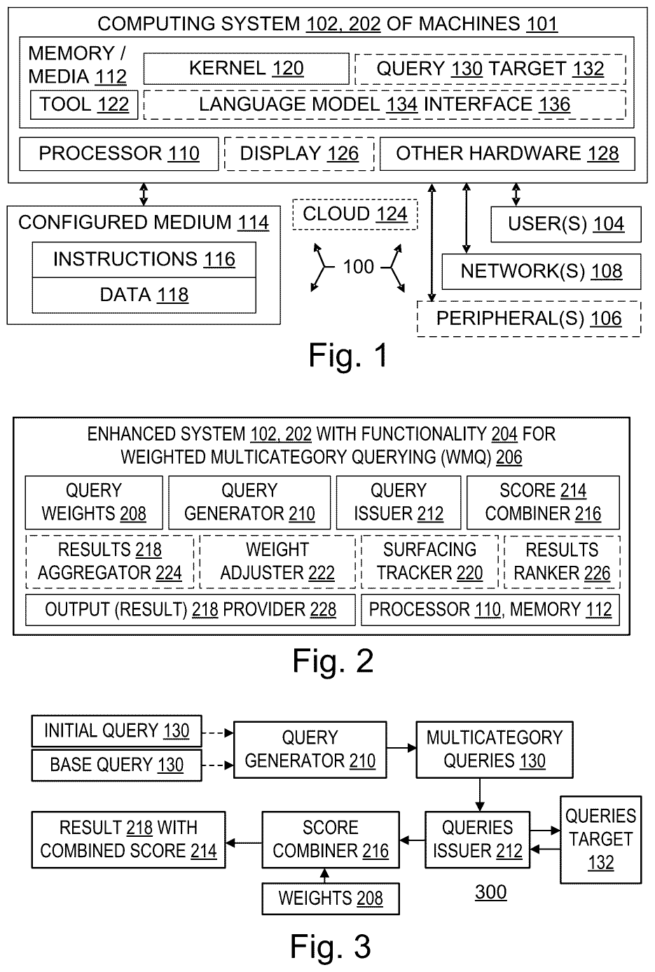

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Storage devices or networking devices or both are considered peripheral equipment 106 in some embodiments and integral parts of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, editors, compilers, debuggers and other software development tools, document processing tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, physical measurements, sensor data, and so forth.

Although an embodiment may include software instructions executed by one or more processors in a computing device (e.g., general purpose computer, server, or cluster), such description is not meant to exhaust all possible embodiments. Embodiments do not necessarily include any software. One of skill will understand that the same or similar functionality of software can often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one or more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) are present in operable communication with one or more processors 110 and memory 112.

In some embodiments or operating environments, a system includes multiple computers connected by a wired and/or wireless network 108. Networking interface equipment 128 provides access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected from, or only intermittently connected to, another networked device or remote cloud or the internet. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings do not provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be properly added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment, which are disclosed herein but not tied to a particular reference numeral. Corresponding drawings may also be properly added.

### More About WMQ Systems

Specific items called out in the figures are discussed at various points herein. FIG. 2 illustrates a computing system 102 or other system configured by one or more of the WMQ functionality enhancements taught herein, resulting in an enhanced system 202. In some embodiments, an enhanced system 202 includes a single machine (computational or not), a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with WMQ functionality 204. In some embodiments consistent with FIG. 3, components shown in FIG. 2 or other figures are also present.

WMQ stands for weighted multicategory querying, also referred to as weighted multiform querying. WMQ 206 refers to generation of multiple queries which belong collectively to multiple categories 508, with the multiple queries being generated from a single input query that does not itself explicitly match all of the categories 508 of the generated queries, and also refers to weights being associated with the generated queries. Each category of the generated queries has a respective weight 208; the values for two weights may be the same at times, but those values are nonetheless held in distinct variables.

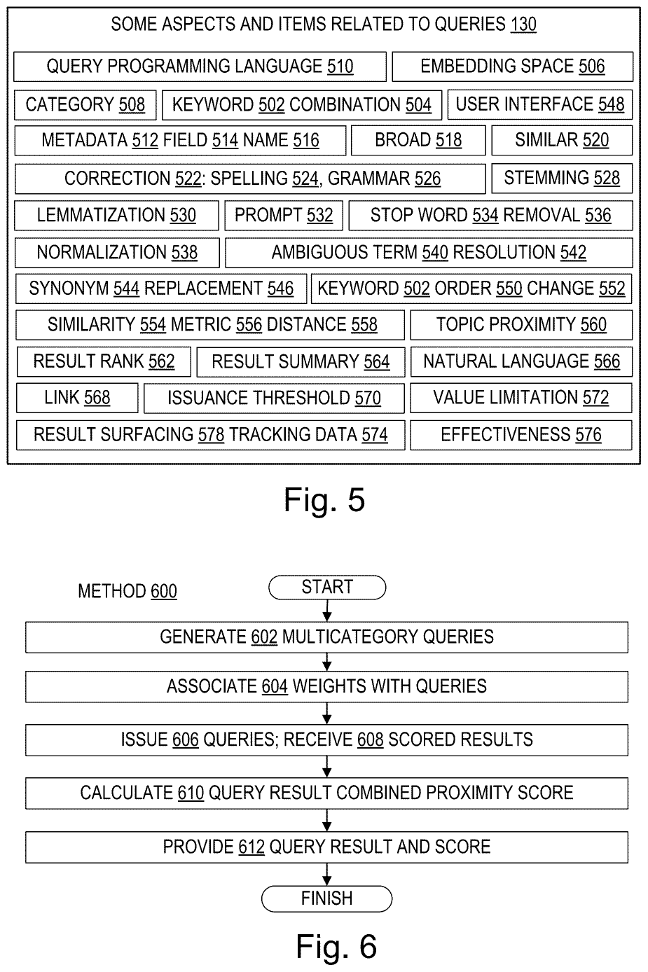

FIGS. 1-5 do not individually or collectively or in any subset fully define a comprehensive summary of all aspects of enhanced systems 202 or all aspects of WMQ functionality 204. Nor is any figure of FIGS. 1-5 or any group of figures of FIGS. 1-5 by itself a comprehensive summary of all aspects of an environment 100 or another context of an enhanced system 202.

The other figures are also pertinent to systems 202. FIGS. 6 to 11 are flowcharts which illustrate some methods of WMQ functionality 204 operation in some systems 202.

In some embodiments, the enhanced system 202 is networked through an interface 128. In some, an interface 128 includes hardware such as network interface cards, software such as network stacks, APIs, or sockets, combination items such as network connections, or a combination thereof.

Some embodiments include a computing system 202 which is equipped, structured, or otherwise configured to utilize or provide WMQ functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous address block or of a single kind, e.g., a memory 112 may include hard drive memory as well as volatile RAM, and may include memories that are physically located on different machines 101, but “memory” alone also includes systems with multiple memories. Similarly, the phrase “processor set” is used to emphasize that a processor 110 is not necessarily confined to a single chip or a single machine 101, but “processor” alone also includes systems with multiple processors.

All sets herein are non-empty unless described otherwise. At a given point in time any data structure implementing a set identified in this description is empty, or is non-empty, depending on the embodiment and the circumstances. However, even an empty set is defined and detectable in the system 202 as a set when an embodiment includes a data structure implementing the set. The absence of members of a set is not the absence of the set itself.

In this example, a computing system 202 includes at least one processor 110, which is in operable communication with at least one digital memory 112. The at least one digital memory includes volatile storage and non-volatile storage unless indicated otherwise.

Some embodiments include a computing system 202 including: a digital memory 112; a processor 110 in operable communication with the digital memory; query weights 208 including a keyword combination 504 query weight, a query programming language 510 query weight, and an embedding space 506 query weight, each of the query weights residing in the digital memory; a query generator 210 including instructions 116 which upon execution by the processor generate 602 multiple queries 130 from an initial query or from a base query which is derived from the initial query, the multiple queries including a keyword combination 504 query 130, a query programming language 510 query 130, and an embedding space 506 query 130; a query issuer 212 including instructions 116 which upon execution by the processor issue 606 a plurality of the multiple queries and in response receive 608 respective query results 218; a score combiner 216 including instructions 116 which upon execution by the processor calculate 610 respective combined topic proximity scores 214 for a plurality of the query results, each combined topic proximity score calculated for a particular query result from at least the keyword combination query weight, a keyword combination query result topic proximity score of the particular query result, the query programming language query weight, a query programming language query result topic proximity score of the particular query result, the embedding space query weight, and an embedding space query result topic proximity score of the particular query result; and an output provider 228 including instructions 116 which upon execution by the processor output 612 the particular query result and the combined topic proximity score of the particular query result.

In some embodiments, the computing system 202 includes a ranker 226, the ranker including instructions 116 which upon execution by the processor submit 1110 the particular query result and the combined topic proximity score of the particular query result to a learning-to-rank model 460, and in response receive 1112 a rank 562 of the particular query result. Depending on the embodiment, the learning-to-rank model operates on results in a pointwise manner (individual results are ranked), a pairwise manner (pairs of results are ranked relative to each other), or a listwise manner (an entire list of results is ordered).

In some embodiments, the computing system 202 includes a results aggregator 224, the results aggregator including instructions 116 which upon execution by the processor summarize 1114 multiple ranked query results into a natural language 566 summary 564.

In some embodiments, the computing system 202 includes the query programming language 510 query 130, and the query programming language query includes a metadata query 1118, 130 which specifies a metadata field 514 and a corresponding value limitation 572 for the metadata field.

In some embodiments, the query weights 208 are first weights configured for utilization by the score combiner 216 on behalf of a first weights entity 104, and the computing system 202 further includes second weights 208 configured for utilization by the score combiner on behalf of a second weights entity 104. That is, in these embodiments the query weights 208 are personalized or otherwise customized. In particular, in some embodiments and scenarios query weights are customized to a particular cloud tenant or another holder of one or more specified cloud computing accounts.

In some embodiments, the query issuer 212 includes instructions 116 which upon execution by the processor skip 704 issuing a query in a particular category 508 in response to a determination 702 that the weight corresponding to that particular category is below a query issuance threshold 570. In one example, an initial query is “show top five locations with most salespeople”, which is determined to be narrow and best suited to the keyword and query language categories. The embedding space category receives a weight of 0.1 for this narrowly focused initial query, but has an issuance threshold of 0.4, so no embedding space query is issued.

In some embodiments, the computing system 202 includes a surfacing tracker 220, the surfacing tracker including instructions 116 which upon execution by the processor track 1120 surfacing of query results, wherein surfacing includes at least one of: following 1122 a link 568 to a tracked query result, following 1122 a link 568 in a tracked query result, copying 1124 from a tracked query result, exporting 1126 a tracked query result, opening 1128 a tracked query result, printing 1130 from a tracked query result, scrolling 1132 in a display of a tracked query result, or displaying 1134 at least a portion of tracked query result.

In some embodiments, the computing system 202 includes a query weight adjuster 222, the query weight adjuster including instructions 116 which upon execution by the processor adjust 804 at least one of the query weights in response to tracking data 574 obtained by the surfacing tracker. In one example, results from the lowest weight category were surfaced more than results from the highest weight category. Accordingly, the highest weight is reduced, the lowest weight is increased, or both.

In some embodiments, the computing system 202 includes a query weight adjuster 222, the query weight adjuster including instructions 116 which upon execution by the processor perform at least one of: adjusting 804 a query weight to favor a metadata 512 query 130 in response to a determination 902 that a metadata field 514 is specified in the initial query or the base query or both; adjusting 804 a query weight to favor the query programming language 510 query 130 in response to a determination 1162 that a keyword 502 is specified in the initial query or the base query or both; adjusting 804 a query weight to favor the keyword 502 query 130 in response to a determination 1162 that a keyword 502 is specified in the initial query or the base query or both; adjusting 804 a query weight to favor the query programming language 510 query 130 in response to a determination 1162 that a keyword 502 is specified in the initial query or the base query or both; or adjusting 804 a query weight to favor the embedding vector 506 query 130 in response to a determination 802 that the initial query is broad 518 or a determination 802 that the base query is broad 518, or both.

In some embodiments, query breadth 518 is computed from one or more data such as the number of keywords in the query (fewer implies broader), a presence in or an absence from the query of words from a list of generic words, an absence from the query of specific items such as colors, proper nouns, quantities, dates, or quoted strings, a number of keyword search results which is below a lower threshold such as ten or above an upper threshold such as one thousand, or a classification of the query from a language model prompted to state whether the query is broad.

The following example is designed to illustrate multiple capabilities of WMQ functionality 204. Any particular given embodiment does not necessarily include all of these illustrated capabilities, and any particular input to a system 202 does not necessarily result in all of these illustrated operations.

An initial query input to a tool 122, 204 user interface is “Iot m2m secure breech custamer reports”. Via an LLM this tool corrects 522 spelling and grammar, deriving the query “Iot m2m security breach customer reports”. Via an LLM or a list lookup, this tool normalizes 538 “Iot” to “internet of things”, deriving the query “internet of things m2m security breach customer reports”. Via an LLM or a list lookup, this tool normalizes “m2m” to “machine-to-machine”, or in a variation, the tool uses an LLM or a list lookup to resolve 542 “m2m” to “machine-to-machine” instead resolving “m2m” to a company name or a musical group name. Either way, the next derived query is “internet of things machine-to-machine security breach customer reports”.

Next, some keywords (keyword 502 includes a single word or a multiword phrase) are re-ordered 1016 to generate multiple queries: “internet of things machine-to-machine security breach customer reports” “security breach internet of things machine-to-machine customer reports” “customer reports internet of things machine-to-machine security breach”

Next, additional queries are generated by replacing 546 “customer” with a semantically similar word (per an LLM or a list lookup) “client” or “account”: “internet of things machine-to-machine security breach customer reports” “security breach internet of things machine-to-machine customer reports” “customer reports internet of things machine-to-machine security breach” “internet of things machine-to-machine security breach client reports” “security breach internet of things machine-to-machine client reports” “client reports internet of things machine-to-machine security breach” “internet of things machine-to-machine security breach account reports” “security breach internet of things machine-to-machine account reports” “customer reports internet of things machine-to-machine account breach”

Thus far in this example, queries are not yet categorized 508. Each of the nine derived queries above serves as a base query, from which up to three categorized queries are derived because there are three categories in use in this example, resulting in up to 3×9=27 categorized queries. Fewer categorized queries are generated, e.g., when metadata fields take on enumerated values rather than freeform values. For instance, in this particular example “customer reports”, “client reports” and “account reports” each map to a value “user” in a metadata field named “report_source”. Three categorized queries are illustrated below with their respective category indicated for convenience in square brackets; other categorized queries correspond similarly to respective derived queries above:
[keyword combination](“internet of things”, “machine-to-machine”, “security”, “breach”, “customer”, “report”)
[metadata]((report_source: user) AND (report_subject: security) AND (product_desc: “internet of things” OR product_group: iot))
[embedding vector](0.132, −1.221, 2.303, . . . , 0.577)

In this example, weights are associated with the query categories as follows. The greatest weight is associated with the embedding vector category because terms such as “security”, “breach”, “customer”, and “report” are broad. Next greatest is the weight associated with the metadata query, because metadata field names report_source and report_subject are indicated in the base query.
keyword combination weight=0.3
metadata weight=0.56
embedding vector weight=0.72

In this example, the keyword combination query uses AND as the operator between keywords when the query is broad, to make the results more focused on items with high topic proximity, and to reduce the number of results to a manageable size. Some embodiments use OR as the operator when the query is not classified as broad.

Different queries will tend to produce at least some different results than each other, so the topic proximity of the individual results and the weights of the category(ies) in which the results are received are utilized to calculate 610 a combined topic proximity score for a result, which is suitable for ranking the result.

For instance, in this example a result001k is received in response to a keyword combination query and is not received in response to any query in a different category (effectively being given topic proximity score 0 in those other categories), and is given a topic proximity score of 0.09 on a scale of 0.0 (not proximate, i.e., not close) to 1.0 (most proximate, i.e., most close) by a search engine or full text search tool or other target 132 of the keyword combination query. Then the combined topic proximity score for result001 k is 0.09*0.3+0*0.56+0*0.72=0.027.

In this example a result002m with topic proximity 0.8 is received in response to a metadata query, a result002e with topic proximity 0.7 is received in response to an embedding space query, and result002m overlaps result002e in a result portion result002me. No result overlapping result002me and having topic proximity above a cutoff 0.05 is received from the keyword query. Then the combined topic proximity score for result002me is 0*0.3+0.8*0.56+0.7*0.72=0.952.

The foregoing are only examples. Other embodiments and scenarios issue different queries, associate different weights with query categories, calculate the combined topic proximity score differently (e.g., by scaling it, or using different cutoffs), do not check for overlap between results received, or otherwise depart from this example while nonetheless remaining consistent with teachings presented herein.

Other system embodiments are also described herein, either directly or derivable as system versions of described processes or configured media, duly informed by the extensive discussion herein of computing hardware.

Although specific WMQ architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of WMQ functionality, for example, as well as different technical features, aspects, interfaces, mechanisms, software, expressions, operational sequences, commands, data structures, programming environments, execution environments, environment or system characteristics, agents, proxies, or other functionality consistent with teachings provided herein, and may otherwise depart from the particular examples provided.

WMQ Processes (a.k.a. Methods)

Processes (which are also referred to as “methods” in the legal sense of that word) are illustrated in various ways herein, both in text and in drawing figures. FIGS. 6 to 11 each illustrate a family of WMQ methods 600, 700, 800, 900, 1000, and 1100 respectively, which are performed or assisted by some enhanced systems, such as some systems 202 or another functionality enhanced system as taught herein. Method families 600 through 1000 are each a proper subset of method family 1100. Moreover, activities identified in FIGS. 1 to 5 as explicit or implicit method steps are likewise incorporated into method 1100, e.g., feature extraction, chunking, embedding, model training, publishing, A/B testing, caching, vectorizing, storing, retrieving, and so on. Also, steps that are not expressly tied herein to a particular reference number are not thereby excluded from method 1100. These diagrams and flowcharts are merely examples; as noted elsewhere, any operable combination of steps that are disclosed herein may be part of a given embodiment when called out in a claim.

Technical processes shown in the Figures or otherwise disclosed are performed automatically, e.g., by an enhanced system 202, unless otherwise indicated. Related non-claimed processes may also be performed in part automatically and in part manually to the extent action by a human person is implicated, e.g., in some situations a human 104 types text into a user interface. Regardless, no process contemplated as an embodiment herein is entirely manual or purely mental; none of the claimed processes can be performed solely in a human mind or on paper. Any claim interpretation to the contrary is squarely at odds with the present disclosure.

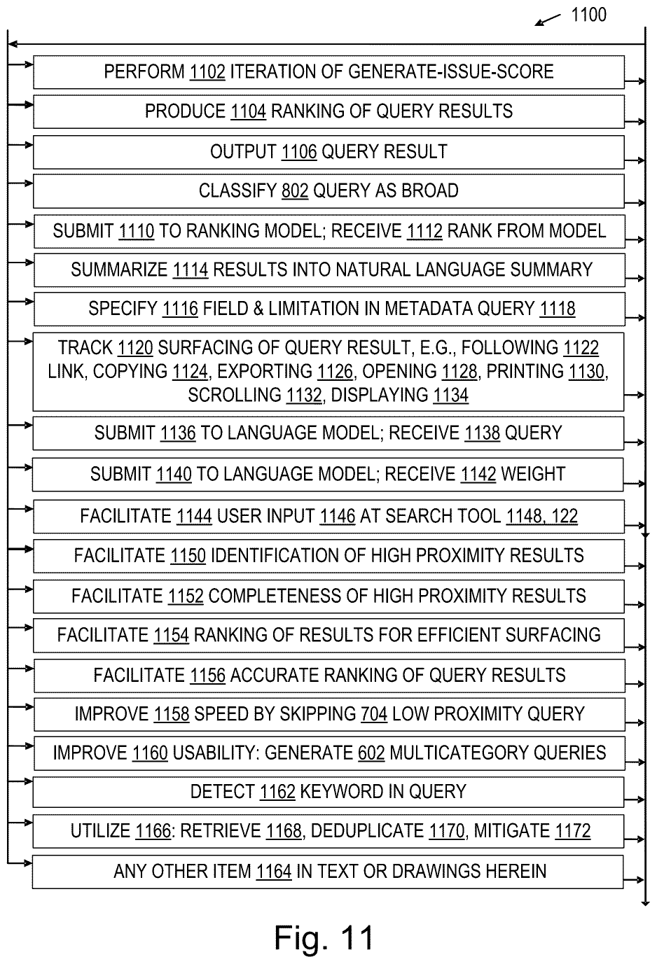

In a given embodiment zero or more illustrated steps of a process may be repeated, perhaps with different parameters or data to operate on. Steps in an embodiment may also be done in a different order than the top-to-bottom order that is laid out in FIG. 11. FIG. 11 is a supplemental portion of the textual and figure drawing examples of embodiments provided herein and the descriptions of embodiments provided herein. In the event of any alleged inconsistency, lack of clarity, or excessive breadth due to an interpretation of FIG. 11, the content of this disclosure shall prevail over that interpretation of FIG. 11.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1100 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 11 to be non-operable, the sequence S is not within the scope of any claim. Any assertion otherwise is contrary to the present disclosure.

Some embodiments provide or utilize a WMQ method 1100 which is performed by a computing system. The method includes: generating 602 a first query 130 from a base query 130, the first query belonging to a first query category 508; generating 602 a second query 130 from the base query, the second query belonging to a second query category 508 which differs from the first query category, each of the first query category and the second query category including at least one of: a keyword combination 504 category, a query programming language 510 category, or an embedding space 506 category; associating 604 a first query weight 208 with the first query; associating 604 a second query weight 208 with the second query; issuing 606 the first query and in response receiving 608 a query result 218 and receiving a first query result topic proximity score 214; issuing 606 the second query and in response receiving 608 the query result 218 and receiving a second query result topic proximity score 214; calculating 610 a query result combined topic proximity score 214 from at least the first query result topic proximity score, the first query weight, the second query result topic proximity score, and the second query weight; and providing 612 the query result and the query result combined topic proximity score to a results ranker 226.

In some embodiments, method includes utilizing 1166 an output of the results ranker 226 by performing at least one of: a document retrieval 1168, a document deduplication 1170, or a risk mitigation action 1172. For example, the N most highly ranked documents are proactively retrieved in some scenarios, N<=10, for instance. In some scenarios, equally ranked documents are treated as duplicates, e.g., only one of them is retrieved or subjected to analysis. In some scenarios, exfiltration risk is mitigated and computational resources conserved by scanning for documents marked or labeled as sensitive in response to their high ranking. These are examples, not a complete list of all utilizations of ranks 562.

In some embodiments, performing 1102 a first iteration of the method 1100 provides the results ranker with a first query result and a first query result topic proximity score; performing 1102 a second iteration of the method provides the results ranker with a second query result and a second query result topic proximity score; the results ranker produces 1104 a ranking 562 of the first query result relative to the second query result according to at least the first query result topic proximity score and the second query result topic proximity score; and the results ranker outputs 1106 a highest ranked query result according to the ranking.

In some embodiments, the first query 130 belongs to the query programming language 510 category 508; generating 602 the first query from the base query includes detecting 902 a metadata field name 516 or a portion thereof or a synonym thereof in the base query; and in response to the detecting, the method includes increasing 804 the first query weight relative to the second query weight.

In some embodiments, the first query 130 belongs to the embedding space 506 category 508; generating 602 the first query from the base query includes classifying 802 the base query as a broad query; and in response to the classifying, the method includes increasing 804 the first query weight relative to the second query weight.

In some embodiments, generating 602 the first query or generating 602 the second query or both includes performing at least one of: a spelling correction 524; a grammar correction 526; a stemming 528 or a lemmatization 530 or both; or a stop word 534 removal 536. Natural language processing software, or language models, or both, are adapted to perform these operations, in some embodiments.

In some embodiments, generating 602 the first query or generating 602 the second query or both includes performing at least one of: an ambiguous term 540 resolution 542; a term normalization 538; a change 552 in an order 550 of keywords 502; a replacement 546 of a particular word by a synonym 644 of the particular word; or a replacement 546 of a particular word by a similar word 520 which is within a specified distance 558 of the particular word under a similarity 554 metric 556. Natural language processing software, or language models, or both, are adapted to perform these operations, in some embodiments.

### WMQ Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, is configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing WMQ functionality 204 as disclosed herein. The Figures thus help illustrate configured storage media embodiments and process (a.k.a. method) embodiments, as well as system and process embodiments. In particular, any of the method steps illustrated in FIGS. 6 to 11, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform a WMQ method 1100. This method 1100 includes: generating 602 a first query 130 from a base query, the first query belonging to a first query category 508; generating 602 a second query 130 from the base query, the second query belonging to a second query category 508 which differs from the first query category, each of the first query category and the second query category including at least one of: a keyword combination 504 category, a query programming language 510 category, a metadata 512 query category, or an embedding space 506 category; associating 604 a first query weight 208 with the first query; associating 604 a second query weight 208 with the second query; issuing 606 the first query and in response receiving 608 a query result 218 and receiving a first query result topic proximity score 214; issuing 606 the second query and in response receiving 608 the query result and receiving a second query result topic proximity score 214; calculating 610 a query result combined topic proximity score 214 from at least the first query result topic proximity score, the first query weight, the second query result topic proximity score, and the second query weight; and outputting 1106 the query result and the query result combined topic proximity score to a user interface 548 of the computing system.

In some embodiments, the method includes: submitting 1136 (e.g. via an API or other interface 136) an initial query to a language model 134 with a prompt 532 to perform at least one of: a grammar correction 526, an ambiguous term resolution 542, a term normalization 538, a change 552 in an order of keywords 502, a replacement 546 of a particular word by a synonym 544 of the particular word, or a replacement 546 of a particular word by a similar 554 word which is within a specified distance 558 of the particular word under a similarity metric 556; and receiving 1138 (e.g. via an API or other interface 136) the base query 130 in response to at least the prompt.

In some embodiments, the method includes: submitting 1136 (e.g. via an API or other interface 136) to a language model 134 a prompt 532 to perform at least one of: generating 602 the first query, or generating 602 the second query; and receiving 1138 (e.g. via an API or other interface 136) the first query or the second query or both, in response to at least the prompt.

In some embodiments, the method includes: submitting 1140 to a language model 134 (e.g. via an API or other interface 136) a prompt 532 to perform at least one of: associating 604 the first query weight with the first query, or associating 604 the second query weight with the second query; and receiving 1142 (e.g. via an API or other interface 136) the first query weight or the second query weight or both, in response to at least the prompt.

In some embodiments, the method satisfies at least one of: the method facilitates 1144 user input 1146 at a search tool 1148, 122 by generating 602 multiple queries 130 in different query categories 508 in response to a single initial query 130 received as input 1146; the method facilitates 1150 identification of highly proximate query results 218 in a search tool by generating multiple queries in different query categories in response to a single initial query received as input; the method facilitates 1152 completeness of highly proximate query results in a search tool by generating multiple queries in different query categories in response to a single initial query received 1002 as input; the method facilitates 1154 ranking 562 of query results for efficient surfacing 578 in a search tool by adjusting 804 the first query weight or the second query weight in response to a determination 902 or 1162 or both that the initial query includes at least one of: a metadata field 514, or a keyword 502; the method facilitates 1154 ranking 562 of query results for efficient surfacing 578 in a search tool by adjusting 804 the first query weight or the second query weight in response to a classification 802 of the initial query as broad 518; the method facilitates 1156 accurate ranking of query results in a search tool by adjusting 804 the first query weight or the second query weight in response to a determination 902 or 1162 or both that the initial query includes at least one of: a metadata field, or a keyword; or the method facilitates 1156 accurate ranking of query results in a search tool by adjusting 804 the first query weight or the second query weight in response to a classification 802 of the initial query as broad 518.

### Additional Observations on WMQ

Support for the discussion of WMQ functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or with any reference external to the present disclosure, has no role in interpreting the claims presented in this patent disclosure. It is in the context of this understanding, which pertains to all parts of the present disclosure, that examples and observations are offered herein.

In some approaches, a search for topically proximate data involves three primary methods: semantic search, keyword-based search, and metadata filtering using expressions written in a query programming language 510 such as Keyword Query Language (KQL). When these search methods are executed separately, users select and apply each search method individually. This fragmented search process leads to inefficiencies, incomplete search results, and a disjointed user experience. Critical information can be missed when searches are not conducted comprehensively.

Some embodiments taught herein address these limitations by providing or utilizing an advanced omni-search capability 204. Some of these embodiments enable users to input a single query from which the system 202 seamlessly derives a combination of search criteria, incorporating semantic, keyword, and metadata filters. Some embodiments intelligently identify and process each component of the initial query independently. Once the component searches are executed, the search results are merged and ranked dynamically, aligning with the user's original input.

Some embodiments provide or perform a method for semantic searching and filtering which includes: generating different kinds of query from an initial query, such as a keyword query, a metadata query, or an embedding vector query; ranking the queries according to topic proximity; issuing one or more of the queries; and ranking the query results according to topic proximity. Some variations or refinements include modifying the initial query by at least one of: a spelling correction, a grammar correction, an ambiguous term resolution, a term normalization, changing 1016 keyword order, stemming or lemmatization, stop word removal, replacing 1018 a word by a synonym, or replacing 1018 a word by a similar word based on vector embedding distance. Some other variations or refinements include: using a query programming language; adjusting query weight to favor the metadata query when a metadata field is specified 1116 in the initial query; adjusting query weight to favor the keyword query when a keyword is specified in the initial query; adjusting query weight to favor the embedding vector query when the initial query is broad; submitting a query result and topic proximity score to a learning-to-rank model, receiving a rank of the result from the learning-to-rank model, sending the rank to a results aggregator, and summarizing the ranked results into a summary.

Some embodiments provide or utilize a method 1100 for semantic searching and filtering. As examples of application areas, security investigation and legal investigation into electronic documents are offered, but teachings are not limited to those areas.

To enhance accuracy and topic proximity 560, some embodiments employ a combination of query analysis, ranking algorithms, and large language models (LLMs). This integration helps ensure that each search component—whether semantic, keyword-based, or metadata-driven—is weighted appropriately and contributes meaningfully to the final output. By leveraging LLMs for query understanding and result ranking, the omni-search approach 206 delivers a more thorough, efficient, and user-centered solution, ultimately streamlining the search process and improving the quality of insights derived from complex datasets.

Some embodiments combine multiple search types 508 (e.g., query-based corrected keyword, keyword combinations, KQL, and embedding-based semantic search types), and include a ranking and topic proximity that adjusts the influence of semantic fuzziness and logical filtering. One embodiment involves: Query Correction wherein an LLM first corrects 1006, 1008 the user's query for spelling, grammar, and context, helping to ensure an accurate interpretation of the query goal; Conversion to Keyword Combinations wherein the LLM reformulates the corrected query into multiple keyword combinations, covering proximate synonyms, variations, and term orders to enhance the search scope; KQL Query Construction for Metadata Fields wherein upon determining that the query suggests specific metadata topic proximity (e.g., author, date, or document type), the LLM constructs a KQL (Keyword Query Language) query that targets these fields, enabling structured filtering within metadata; Embedding-Based Query Representation wherein the query is also converted to an embedding format, allowing for semantic similarity matching that retrieves contextually proximate documents even without exact keyword matches; and Dynamic Weight Assignment for Query Sources wherein each query format 508 (corrected keyword, keyword combinations, KQL, and embedding-based) is issued 606 separately, and the LLM assigns dynamic weights to each query source, ranking results based on the context and computationally ascertained goal of the query.

Some embodiments generate 602 several different kinds of query from an initial query, retrieve 608 search results for each generated query, calculate 610 a topic proximity score for each search result for each kind of generated query, assign 610 each search result an overall topic proximity score based on a weighted sum of the calculated topic proximity scores, and rank 562 the search results based on topic proximity scores 214. Some examples of the different kinds of query include spelling and grammar corrected, keyword, keyword query language, and semantic embedding vector, among others.

Some embodiments provide or utilize a WMQ method 1100 for improving search topic proximity and precision by combining keyword-based and semantic search techniques in particular ways. Some methods 1100 leverage a large language model (LLM) to analyze, rewrite 602, and dynamically weight user queries in multiple forms 508 to support a comprehensive search approach. This allows an embodiment to handle complex, nuanced investigation queries 130 with enhanced accuracy, helping to ensure that topically proximate documents 118 are retrieved across various formats and contexts.

In some embodiments, a method 1100 includes Query Correction. The LLM corrects the user's query for spelling, grammar, and context, helping to ensure an accurate interpretation of the query.

In some embodiments, a method 1100 includes Conversion to Keyword Combinations. The LLM reformulates 552, 602 the corrected query into multiple keyword combinations, covering pertinent synonyms, variations, and term orders 550 to enhance the search scope.

In some embodiments, a method 1100 includes KQL Query Construction for Metadata Fields. When the query suggests specific metadata topic proximity (e.g., author, date, or document type), the LLM constructs 602 a KQL (Keyword Query Language) query that targets these fields, enabling structured filtering within metadata. In addition, or instead, the LLM constructs 602 at least one query in another query programming language than KQL, e.g., Structured Query Language (SQL), XQuery, T-SQL, Lucene, or N1QL. In some environments, a query programming language includes a command interface, a syntax-checking mechanism, an execution engine, and a data return function. Query programming languages 510 include commands to retrieve, insert, update, and delete data, for example; some also enable aggregate functions such as sum, count, average, and max.

In some embodiments, a method 1100 includes Embedding-Based 506 Query Representation. The query is converted to an embedding vector, allowing semantic similarity matching that retrieves contextually pertinent documents even without exact keyword matches.

In some embodiments, a method 1100 includes Dynamic Weight Assignment for Query Sources. Each query category (e.g., corrected keyword, keyword combinations, KQL, embedding-based) is issued separately, and the LLM assigns dynamic weights to each query source, ranking query results based on the context and goal of the query.

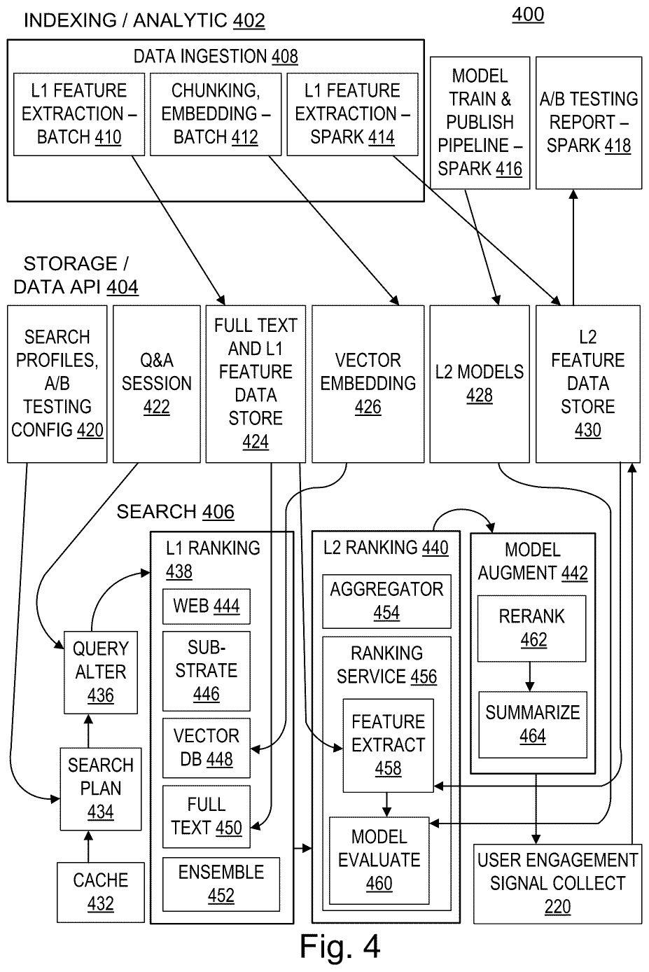

FIG. 4 illustrates a detailed workflow 400 of one of the many embodiments that incorporate teachings of the present disclosure. The illustrated workflow has three sections: an indexing and analysis section 402, a storage and data API section 404, and a search section 406. Data flows between sections as indicated by the arrows.

In indexing and analysis section 402, a data ingestion module 408 includes instructions 116 which upon execution perform batch level one (L1) feature extraction 410, batch chunking and embedding 412, and Spark-based or similar level two (L2) feature extraction 414. Spark software provides tools for in-memory data processing, large-scale data manipulation, and machine learning algorithms. Indexing and analysis section 402 also includes instructions 116 which upon execution perform Spark-based machine learning model training and publishing 416, and instructions 116 which upon execution perform Spark-based A/B testing and reporting 418.

In storage and data API section 404, configuration data for search profiles and A/B testing are stored in an initialization file 420. Question-and-answer (Q&A) session data is stored in a cache 432 or a globally distributed, multi-model database service 422 or both. Full text and L1 feature data is stored in a data store 424, with query programming language access. Vector embedding data is stored in a data store 426, with query programming language access. L2 models are stored in cloud blobs 428. L2 feature data is stored in a globally distributed, multi-model database service 430 (or 422) or a data store 430 with query programming language access.

In search section 406, data flows from a cache 432 and configuration 420 into a search planner 434, and then to query alteration 436 (an example of query correction 522 and of query modification 1004). An L1 ranking module 438 includes instructions 116 which upon execution perform query issuance 606 and level one ranking of received 608 query results 218. L1 ranking module 438 includes a web engine search interface 444, a substrate search mechanism 446, a vector database search with similarity ranking component 448, and a full text search with BM25 (“Best Match 25”) ranking component 450. Although for clarity of illustration this dataflow is not shown, an ensemble component 452 gathers the search results of these components 444, 446, 448, 450.

An L2 ranking module 440 includes instructions 116 which upon execution perform level two ranking. L2 ranking module 440 includes a ranking aggregator 454 and one or more instances of a ranking service 456. Each ranking service 456 instance includes a feature extraction component 458 and a model evaluation component 460, e.g., a decision tree component 460 or a deep neural network component 460.

An LLM augmentation module 442 includes instructions 116, 462 which upon execution perform re-ranking, and instructions 116, 464 which upon execution perform summarization.

A user engagement signal collection module 220 collects result surfacing tracking data 574.

In some embodiments, a Query Alteration Component 436 is designed to enhance search flexibility and topic proximity by generating 602 multiple forms of a single query 130, which could be an initial query input by a user or a base query derived from such initial query. This component 436 processes the initial user query and generates various query formats, thereby maximizing retrieval accuracy and coverage across diverse data structures. By converting a query into corrected, keyword-based, structured, and semantic forms, the component 436 supports precise matching, broad conceptual recall, and metadata-specific filtering. By dynamically assigning weights to each query form (i.e., each generated query in its respective category), the embodiment prioritizes the most contextually proximate results, optimizing both precision and recall.

In some embodiments, Query Correction includes Spelling and Grammar Correction. The Query Alteration Component 436 or query generator 210 uses natural language processing (NLP) techniques to identify and correct spelling errors, typos, and grammatical mistakes within the query. For example, a query “cyber seurity threat in finanace” is corrected to “cybersecurity threat in finance.”

In some embodiments, Query Alteration Component 436 or query generator 210 perform Ambiguity Resolution 542 which refines ambiguous terms based on context. For instance, the term “AI” is expanded to “artificial intelligence” when the surrounding terms suggest this resolution, e.g., by the presence of terms sufficiently closely related semantically to “artificial intelligence”.

In some embodiments, Query Alteration Component 436 or query generator 210 perform Normalization of Terms to help ensure consistency by converting abbreviations or jargon into more widely used or standard terms. For instance, “IoT” is converted to “Internet of Things” to improve match reliability.

In some embodiments, Query Alteration Component 436 or query generator 210 perform Keyword Extraction and Reordering by identifying key terms in the query and generating multiple combinations by reordering terms. For example, “data privacy laws in healthcare” yields combinations such as “healthcare data privacy laws” or “laws on data privacy in healthcare.” Keywords are extracted, e.g., using parsing and lookup techniques adapted from source code compilers, or using natural language processing techniques such as named entity recognition, or both.

In some embodiments, Query Alteration Component 436 or query generator 210 perform Synonym and Variation Generation, using synonym replacement 546 and variant generation to produce alternatives. For example, “cybersecurity” generates “information security” or “data protection.” This enhances the query's reach by accounting for different terminologies used across datasets.

In some embodiments, Query Alteration Component 436 or query generator 210 perform Construction of KQL Queries for Metadata Fields. This includes Metadata Field Recognition. The component 436 or 210 analyzes the query to detect terms that indicate a preference for specific metadata fields, e.g., by parsing, entity extraction, or LLM prompting. For example, terms “author” and “date” imply metadata fields related to authorship, timestamps. This also includes Field Mapping and Structured Query Creation. Based on the detected metadata targeting, the component 436 or 210 maps query terms to metadata fields and constructs a structured query in a query programming language (e.g., KQL, SQL) format. For instance, when the query includes “author John Doe” and “cyber law,” the component generates a query <<author: “John Doe” AND topic: “cyber law”>>.

In some embodiments, Query Alteration Component 436 or query generator 210 perform Construction of embedding, a.k.a., vectorization. The component 436 or 210 uses a pre-trained language model to convert the query into a high-dimensional embedding vector that represents the query's semantic meaning. This allows for similarity-based matching, where documents with related concepts are retrieved, rather than only matching keywords.

With regard to L1 ranking and Dynamic Weight, after the component 436 or 210 has generated at least two query formats (i.e., queries in at least two categories 508), such as corrected, keyword combinations, KQL, and embeddings, the queries are issued 606 independently to the search system(s), e.g., in component 438. Each query type retrieves a set of results tailored to its specific category, resulting in a mix of keyword precision, metadata specificity, and semantic topic proximity. A dynamic weighting module then combines these results based on the query's context, adjusting the emphasis on each query type to optimize topic proximity and recall.

The query weights 208 are dynamically adjusted in response to factors such as query specificity and user preferences, to control a balance between precision (structured queries) and recall (semantic queries). In some embodiments which utilize the particular three categories indicated below, a final topic proximity score (a.k.a. combined topic proximity score) S for each document is calculated as follows:

S=wk*Sk+wkql*Skql+we*Se
where * indicates multiplication, wk+wkql+we=1, and
S is the final topic proximity score of a document across all three categories Sk is the topic proximity score of the result from the keyword-based query Skql is the topic proximity score of the result from the KQL-based query (metadata query/QPL query)
Se is the topic proximity score of the result from the embedding-based query wk is the weight assigned to the keyword-based query
wkql is the weight assigned to the KQL-based query or other QPL-based query we is the weight assigned to the embedding-based query

Utilizing only two categories effectively sets the non-utilized category's weight to zero, with corresponding changes in the formulas above.

In some embodiments, weights are adjusted dynamically based on conditions. For instance, for complex queries requiring specific metadata fields, some embodiments increase Wkql. Also, or instead, for a broad query, some embodiments increase the weight we to capture semantic matches.

In some embodiments, the L2 ranking process utilizes advanced learning-to-rank (LTR) models to rank results obtained from L1 rankers. This example component 440 is implemented as a distributed microservice, enabling efficient execution of decision tree (DT) or deep neural network (DNN) models to update thousands of documents in parallel. The Ranking Aggregator module 454 distributes documents in small batches to the ranking microservice 456 and merges the ranking results. The ranking service 456 loads models based on configuration settings and flight parameters. It evaluates L2 features by loading metadata from the review set and L2 features tables, and ranks results by applying the models to these features.

In some embodiments, an LLM-based aggregation Component provides a concise, context-rich summary of results from the hybrid search process, enabling users to quickly understand the main themes and pertinent information without needing to review each document individually. This component uses a large language model (LLM) to analyze the top-ranked results from the hybrid search 206 which combines keyword-based, KQL, and embedding-based queries. The LLM generates a summary that highlights key points, trends, and insights from the retrieved documents.

In some embodiments, an example LLM prompt 532 for generating weighted query alterations includes: “I have a search query, and I need you to analyze it and generate different alteration forms along with a corresponding weight for each form. The goal is to enhance the query's topic proximity and flexibility for various search contexts. For this query: does mike write email to tony regarding the azure cloud order Analyze the query: Break down its structure, identify key components, and assess potential improvements. Generate query alterations: Query Correction and Expansion: Correct any spelling or grammatical errors, resolve ambiguities, and normalize terms. Metadata Extraction and KQL Generation: Extract pertinent metadata and construct a Keyword Query Language (KQL) representation for precise matching. Conversion to Embedding Format: Represent the query as a semantic embedding for vector-based search systems. Assign weights to each alteration form: Determine the importance of each alteration form in ranking results. Provide reasoning for the assigned weight based on its pertinence or potential impact or relevance to the topic. Output the following for each query alteration form: Altered Query Form: The modified version of the query. Weight: A numeric value representing the importance of this alteration. Explanation: A brief explanation of why the alteration was made and how the weight was determined. Ensure that the results are clear, actionable, and aligned with improving the query's search effectiveness.”

With respect to this prompt an Original Query is: “Does Mike write email to Tony regarding the Azure cloud order?” Query Correction and Expansion produces an Altered Query Form: <<“Did Mike write an email to Tony about the Azure Cloud order?”>> The prompted LLM also produces Weight: 0.4, and Explanation: Corrected grammatical structure for clarity (“does”→“did,” “write email”→“write an email”). Replaced “regarding” with “about” for simplicity. No significant ambiguity was present, and terms were already normalized, so the weight is moderate.

Metadata Extraction and KQL Generation produces an Altered Query Form: <<sender:Mike AND recipient:Tony AND topic: “Azure Cloud order”>>. The prompted LLM also produces Weight: 0.5, and Explanation: Extracted key entities: sender (“Mike”), recipient (“Tony”), and topic (“Azure Cloud order”). Created a structured representation suitable for metadata-driven searches. High topic proximity for systems capable of leveraging structured queries, but limited coverage for broader conceptual matches.

Conversion to Embedding Format produces an Altered Query Form: Semantic embedding vector (e.g., [0.23, −0.41, 0.75, . . . ]) representing the query's conceptual meaning. The prompted LLM also produces Weight: 0.6, and Explanation: Encoded the entire query into an embedding format that captures relationships, goals, and context. High importance for vector-based search systems, especially for retrieving results based on conceptual similarity rather than exact matches. One of skill understands that retrieving results and other computational processing that is based on conceptual similarity operates with digital representations of concepts in a computing system, not with concepts themselves. No claim contemplated herein preempts any abstract concept.

The prompted LLM also produces Summary of Weights:
Query Correction and Expansion: 0.4
Metadata Extraction and KQL Generation: 0.5
Conversion to Embedding Format: 0.6
   This prioritization reflects the potential impact of each alteration form in enhancing search effectiveness for diverse systems. The embedding format ranks highest due to its flexibility in handling both structured and unstructured queries.

One of skill further informed by the teachings herein will recognize several benefits and advantages of various embodiments.

For example, in some embodiments the query issuer includes instructions which upon execution by the processor skip 704 issuing a query in a particular category in response to a determination that the weight corresponding to that particular category is below a query issuance threshold 570. These embodiments enhance search efficiency by selectively bypassing queries with lower assigned weights for specific query alteration forms. Instead of issuing the less proximate queries to an index 132, a database 132, a document corpus 132, or another target 132, the system 202 merges results 218 from prioritized data sources, optimizing performance and reducing unnecessary processing. This helps avoid waste, and increases efficiency through the use of smaller storage and less bandwidth usage.

In some embodiments, effectiveness 576 is significantly improved through the multi-faceted approach to query understanding and correction. The Query Alteration Component processes the initial user query by generating 602 multiple forms, including corrected queries (e.g., by performing at least one of: a spelling correction or a grammar correction), keyword combinations (e.g., by performing a change in an order of keywords), metadata-specific KQL queries, and semantic embeddings. This comprehensive approach helps ensure that both precise keyword matches and broader conceptual connections are captured, enhancing the overall scope and topic proximity of the search.

Some embodiments employ large language models (LLMs) to correct 1006 spelling, resolve 1012 ambiguities, or normalize 1014 terminology within the query, helping to ensure an accurate interpretation of the user's input. By dynamically adjusting weights for each query category, a system 202 prioritizes the most contextually close results, optimizing both precision and recall.

In addition to improving the retrieval process, in some embodiments the LLM-based aggregation component generates concise, context-rich summaries of the top-ranked results. This feature allows users to quickly grasp key insights, themes, and trends without manually reviewing each document, providing a comprehensive understanding of the search outcomes and streamlining decision-making processes.

Some embodiments improve 1158 speed by bypassing unnecessary query forms, or by pre-indexing documents in multiple formats 508, thereby reducing query latency and accelerating search performance.

In some embodiments, accuracy is enhanced by associating respective weights with different query alteration forms and using these weights to adjust the topic proximity ranking of search results. This process is further refined through L2 ranking and LLM-based reranking, which collectively fine-tune the precision of the results.

In some embodiments, the query issuer issue multiple queries in a given category to partitions of a data set. This supports scalability to provide effective querying across large data sets.

By generating queries, with varied corrections and other alterations, in different categories, user input facilitation is enhanced 1160. The user achieves results of a potentially complex and iterative query process from a simpler input.

Some embodiments remove or reduce a particular vulnerability or a particular failure of other approaches. One different approach would perform separate searches using semantic search, keyword-based search, and metadata filtering individually, such a fragmented approach invites inefficiencies, incomplete search results, and overlooked critical information. By contrast, some embodiments of the omni-search capability 204 integrate all three methods-semantic, keyword, and metadata filtering-into a single, unified query. By processing each component independently and then merging the results, an embodiment helps to ensure comprehensive coverage and reduces the risk of missing pertinent data due to fragmented search processes.

Security investigation and legal investigation are noted as examples. Some additional areas in which the present technology would be helpful include (but are not limited here to) financial information retrieval, fraud detection, and regulatory compliance enforcement.

Machine Learning Models, including Language Models

A language model or other machine learning model within or utilized by an enhanced system 202 is not necessarily a large language model (LLM) in every embodiment, but it is an LLM in some embodiments. For present purposes, a language model is “large” if it has at least a billion parameters. For example, GPT-2 (OpenAI), MegatronLM (NVIDIA), T5 (Google), Turing-NLG (Microsoft), GPT-3 (OpenAI), GPT-3.5 (OpenAI), GPT-4 (OpenAI), and LLaMA versions (Meta AI) are each a large language model (LLM) for purposes of the present disclosure, regardless of any definitions to the contrary that may be present in the industry. Some examples of models include language models which are large language models, large language models (LLMs), multimodal language models, and foundation models.

Language model stability is a consideration in some embodiments and some scenarios. Instability leads to inconsistency in language model responses to prompts. Language model stability is sometimes dependent on language model parameters. Some different large language models have different stability parameters, and some exhibit different variability between answers to the same question even while using the same stability parameters. Some models are stabilized by adjusting parameters such as temperature, frequency penalty, presence penalty, or nucleus sampling, and also or instead by constraining the queries sent to a given instance of the model. In some scenarios, model performance is optimized by use of suitable training data, fine-tuning, prompt engineering, or a combination thereof.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as calculating a topic proximity score without employing human senses or human actions, ranking items without employing human senses or human actions, searching documents without employing human senses or human actions, submitting data to a language model without employing human senses or human actions, receiving data from a language model without employing human senses or human actions, and many others which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., language models, rankers, topic proximity score calculators, APIs, and various particular sets of instructions 116 executable by processors 110. None of these are mental concepts or present merely on paper.

In addition, some of the technical effects discussed include, e.g., increased accuracy, increased effectiveness, and increased efficiency, relative to other approaches. Other technical effects are also discussed herein, e.g., in the descriptions of technical benefits or advantages and technical challenges or vulnerabilities.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that the operations performed by functionality 204, and other computational activities described herein are each a technical activity which cannot be performed mentally at all, because the mechanisms in question lack I/O devices that would allow a human to somehow “read” or “write” values within the computing system as described. Hence, computing technology operational improvements such as the various examples of functionality 204 described herein are improvements to computing technology. People manifestly lack the speed and the digital communication and computation capabilities which are required to perform functionality 204 operations as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as a search tool, a filter tool, an analysis tool, a summarization tool, or a categorization tool. The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed relevant to a particular embodiment. However, it does not follow from the availability of a broad context that exclusive rights are being sought herein for abstract ideas; they are not. In particular, no claim is made to search activities generally, or categorization activities generally, as opposed to the particular functionality 204 methods, systems, and devices described and claimed in the eventual final claims based on the present disclosure.

Rather, the present disclosure is focused on providing appropriately specific embodiments whose technical effects fully or partially solve particular technical problems noted herein, e.g., in connection with one of the marker phrases “how to”, “problem”, or “challenge”, or otherwise apparent to one of skill in the art. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human action, but does allow coverage of computational action which is performed in response to human action. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Functionality 204 operations discussed herein (whether recited expressly in the Figures or not), are understood to be inherently non-human. A human mind cannot interface directly with a computing device to perform the functionality 204 steps taught herein. This would all be well understood by persons of skill in the art in view of the present disclosure. Moreover, one of skill understands that functionality 204 cannot be implemented merely with conventional tools and steps, because actual implementation requires the use of teachings which were first provided in the present disclosure, e.g., teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends computationally on at least X, and may also depend computationally on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, with regard to a destination or object, may involve intervening action, such as any action recited in this disclosure or inherent in a step recited in this disclosure, yet still be understood as being performed directly by or on behalf of the party of interest. Example verbs listed herein may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, any and all of the ascertaining, detecting, and determining described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims herein is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A relevant distinction in this example is that a computing system 102 contains one or more machines 101, whereas reference numeral 101 refers to a single machine, e.g., a single laptop, a single smartphone, a single workstation, a single Internet of Things device, etc. However, reference numerals for more general categories are often omitted herein for better readability, particularly when one of skill would acknowledge that the more general category encompasses a more specific category whose reference numeral is recited.

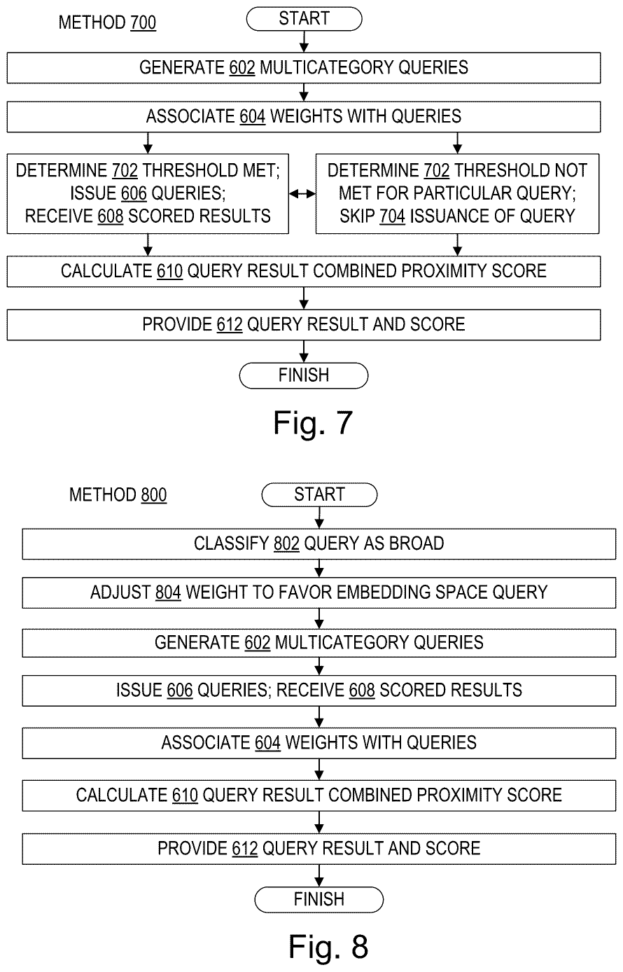

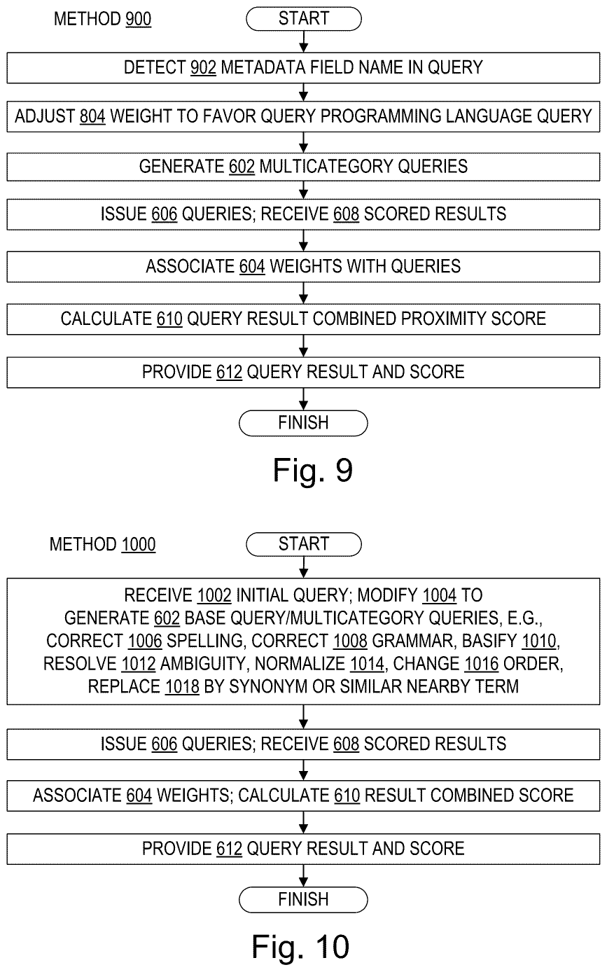

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, web browsers, CIDFP software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
202 enhanced system, i.e., system 102 enhanced with functionality 204 as taught herein
204 WMQ functionality (also referred to as functionality 204), e.g., a mechanism which performs or is configured to perform steps 602, 606, 608,610, and 612, or steps 602, 604, 702, and 704, or steps 802, 804, 606, 608, and 612, or steps 902, 804, 606, 608, and 612, or any mechanism which performs or is configured to perform a sequence of WMQ activities first disclosed herein, or to perform a novel method 1100 first disclosed herein
600 flowchart; 600 also refers to WMQ methods that are illustrated by or consistent with the FIG. 6 flowchart or any variation of the FIG. 6 flowchart described herein
700 flowchart; 700 also refers to WMQ methods that are illustrated by or consistent with the FIG. 7 flowchart or any variation of the FIG. 7 flowchart described herein
800 flowchart; 800 also refers to WMQ methods that are illustrated by or consistent with the FIG. 8 flowchart or any variation of the FIG. 8 flowchart described herein
900 flowchart; 900 also refers to WMQ methods that are illustrated by or consistent with the FIG. 9 flowchart or any variation of the FIG. 9 flowchart described herein
1000 flowchart; 1000 also refers to WMQ methods that are illustrated by or consistent with the FIG. 10 flowchart or any variation of the FIG. 10 flowchart described herein
1010 computationally basify a query by performing one or more of stemming 528, lemmatization 530, or stop word removal 536
1100 flowchart; 1100 also refers to WMQ methods that are illustrated by or consistent with the FIG. 11 flowchart, which incorporates the flowcharts of FIGS. 6 through 10, the steps implicit or express in FIGS. 1 through 5, and all other steps taught herein, or methods that are illustrated by or consistent with any variation of the FIG. 11 flowchart described herein; all WMQ method steps are computational or otherwise artificial, not human activity
1164 any step or item discussed in the present disclosure that has not been assigned some other reference numeral; 1164 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

In some embodiments, a weighted multicategory querying (WMQ) tool 122 generates 602 alternates 130 of an initial query through spelling correction 524, grammar correction 526, natural language processing 528, 530, 536, ambiguous term resolution 542, term normalization 538, keyword reordering 552, synonyms 544, and similar terms 520. The WMQ tool 122 generates 602 additional queries 130 in different weighted categories 508 such as keyword 502 combination 504, query programming language (QPL) 510, metadata 512, or embedding space 506. Query result 218 individual topic proximity scores 214 are combined 216 with category weights 208 to calculate 610 a combined topic proximity score 214, which is employed to rank 562 the query result. Embedding space query weight 208 is increased 804 for queries classified 802 as broad 518. QPL query weight or metadata query weight is increased 804 for queries which contain 1116 part or all of a metadata field name 516. Language models 134 are leveraged for query generation 210, 602, topic proximity scoring 608, or both.

Embodiments are understood to also themselves include or benefit from tested and appropriate security controls and privacy controls such as the General Data Protection Regulation (GDPR), and to comply with all applicable laws and regulations, e.g., the European Union Artificial Intelligence Act (EU AI Act) when applicable. Use of the tools and techniques taught herein can be done together with such controls in compliance with such laws and regulations.

Although Microsoft technology is used in some examples, the teachings herein are not limited to use in technology supplied or administered by Microsoft. Under a suitable license, for example, the present teachings could be embodied in products or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such a standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method performed by a computing system, the method comprising:
generating a first query from a base query, the first query belonging to a first query category;
generating a second query from the base query, the second query belonging to a second query category which differs from the first query category, each of the first query category and the second query category including at least one of: a keyword combination category, a query programming language category, or an embedding space category;
associating a first query weight with the first query;
associating a second query weight with the second query;
issuing the first query and in response receiving a query result and receiving a first query result topic proximity score;
issuing the second query and in response receiving at least the query result and receiving a second query result topic proximity score;
calculating a query result combined topic proximity score from at least the first query result topic proximity score, the first query weight, the second query result topic proximity score, and the second query weight;
providing the query result and the query result combined topic proximity score to a results ranker; and
utilizing an output of the results ranker by performing at least one of: a document retrieval, a document deduplication, or a risk mitigation action.

2. The method of claim 1, comprising:
performing a first iteration of the method of claim 1 provides the results ranker with a first query result and a first query result topic proximity score;
performing a second iteration of the method of claim 1 provides the results ranker with a second query result and a second query result topic proximity score, the first query result topic proximity score either different from or equal to the second query result topic proximity score;
the results ranker produces a ranking of the first query result relative to the second query result according to at least the first query result topic proximity score and the second query result topic proximity score; and
the results ranker outputs a highest ranked query result according to the ranking.

3. The method of claim 1, wherein:
the first query belongs to the query programming language category;
generating the first query from the base query comprises detecting a metadata field name in the base query; and
in response to the detecting, the method comprises increasing the first query weight relative to the second query weight.

4. The method of claim 1, wherein:
the first query belongs to the embedding space category;
generating the first query from the base query comprises classifying the base query as a broad query; and
in response to the classifying, the method comprises increasing the first query weight relative to the second query weight.

5. The method of claim 1, wherein generating the first query or generating the second query or both comprises performing at least one of:
a spelling correction;
a grammar correction;
a stemming or a lemmatization or both; or
a stop word removal.

6. The method of claim 1, wherein generating the first query or generating the second query or both comprises performing at least one of:
an ambiguous term resolution;
a term normalization;
a change in an order of keywords;
a replacement of a particular word by a synonym of the particular word; or
a replacement of a particular word by a similar word which is within a specified distance of the particular word under a similarity metric.

7. A computing system, comprising:
a digital memory;
a processor in operable communication with the digital memory;
query weights comprising a keyword combination query weight, a query programming language query weight, and an embedding space query weight, each of the query weights residing in the digital memory;
a query generator comprising instructions which upon execution by the processor generate multiple queries from an initial query or from a base query which is derived from the initial query, the multiple queries comprising a keyword combination query, a query programming language query, and an embedding space query;
a query issuer comprising instructions which upon execution by the processor issue a plurality of the multiple queries and in response receive respective query results;
a score combiner comprising instructions which upon execution by the processor calculate respective combined topic proximity scores for a plurality of the query results, each combined topic proximity score calculated for a particular query result from at least the keyword combination query weight, a keyword combination query result topic proximity score of the particular query result, the query programming language query weight, a query programming language query result topic proximity score of the particular query result, the embedding space query weight, and an embedding space query result topic proximity score of the particular query result; and
an output provider comprising instructions which upon execution by the processor output the particular query result and the combined topic proximity score of the particular query result.

8. The computing system of claim 7, further comprising a ranker, the ranker comprising instructions which upon execution by the processor submit the particular query result and the combined topic proximity score of the particular query result to a learning-to-rank model, and in response receive a rank of the particular query result.

9. The computing system of claim 8, further comprising a results aggregator, the results aggregator comprising instructions which upon execution by the processor summarize multiple ranked query results into a natural language summary.

10. The computing system of claim 7, further comprising the query programming language query, and wherein the query programming language query comprises a metadata query which specifies a metadata field and a corresponding value limitation for the metadata field.

11. The computing system of claim 7, wherein the query weights are first weights configured for utilization by the score combiner on behalf of a first weights entity, and the computing system further comprises second weights configured for utilization by the score combiner on behalf of a second weights entity.

12. The computing system of claim 7, wherein the query issuer comprises instructions which upon execution by the processor skip issuing a query in a particular category in response to a determination that the weight corresponding to that particular category is below a query issuance threshold.

13. The computing system of claim 7, further comprising a surfacing tracker, the surfacing tracker comprising instructions which upon execution by the processor track surfacing of query results, wherein surfacing comprises at least one of: following a link to a tracked query result, following a link in a tracked query result, copying from a tracked query result, exporting a tracked query result, opening a tracked query result, printing from a tracked query result, scrolling in a display of a tracked query result, or displaying at least a portion of tracked query result.

14. The computing system of claim 13, further comprising a query weight adjuster, the query weight adjuster comprising instructions which upon execution by the processor adjust at least one of the query weights in response to tracking data obtained by the surfacing tracker.

15. The computing system of claim 7, further comprising a query weight adjuster, the query weight adjuster comprising instructions which upon execution by the processor perform at least one of:
adjusting a query weight to favor a metadata query in response to a determination that a metadata field is specified in the initial query or the base query or both;
adjusting a query weight to favor the query programming language query in response to a determination that a keyword is specified in the initial query or the base query or both;
adjusting a query weight to favor the keyword query in response to a determination that a keyword is specified in the initial query or the base query or both;
adjusting a query weight to favor the query programming language query in response to a determination that a keyword is specified in the initial query or the base query or both; or
adjusting a query weight to favor the embedding vector query in response to a determination that the initial query is broad or a determination that the base query is broad, or both.

16. A computer-readable storage medium configured with data and instructions which upon execution by a processor of a computing system perform a method comprising:
generating a first query from a base query, the first query belonging to a first query category;
generating a second query from the base query, the second query belonging to a second query category which differs from the first query category, each of the first query category and the second query category including at least one of: a keyword combination category, a query programming language category, a metadata query category, or an embedding space category;
associating a first query weight with the first query;
associating a second query weight with the second query;
issuing the first query and in response receiving a query result and receiving a first query result topic proximity score;
issuing the second query and in response receiving the query result and receiving a second query result topic proximity score;
calculating a query result combined topic proximity score from at least the first query result topic proximity score, the first query weight, the second query result topic proximity score, and the second query weight; and
outputting the query result and the query result combined topic proximity score to a user interface of the computing system.

17. The computer-readable storage medium of claim 16, wherein the method further comprises:
submitting an initial query to a language model with a prompt to perform at least one of: a grammar correction, an ambiguous term resolution, a term normalization, a change in an order of keywords, a replacement of a particular word by a synonym of the particular word, or a replacement of a particular word by a similar word which is within a specified distance of the particular word under a similarity metric; and
receiving the base query in response to at least the prompt.

18. The computer-readable storage medium of claim 16, wherein the method further comprises:
submitting to a language model a prompt to perform at least one of:
generating the first query, or generating the second query; and
receiving the first query or the second query or both, in response to at least the prompt.

19. The computer-readable storage medium of claim 16, wherein the method further comprises:
submitting to a language model a prompt to perform at least one of:
associating the first query weight with the first query, or associating the second query weight with the second query; and
receiving the first query weight or the second query weight or both, in response to at least the prompt.

20. The computer-readable storage medium of claim 16, wherein the method satisfies at least one of:
the method facilitates user input at a search tool by generating multiple queries in different query categories in response to a single initial query received as input;
the method facilitates identification of proximate query results in a search tool by generating multiple queries in different query categories in response to a single initial query received as input;
the method facilitates completeness of proximate query results in a search tool by generating multiple queries in different query categories in response to a single initial query received as input;
the method facilitates ranking of query results for efficient surfacing in a search tool by adjusting the first query weight or the second query weight in response to a determination that the initial query includes at least one of: a metadata field, or a keyword;
the method facilitates ranking of query results for efficient surfacing in a search tool by adjusting the first query weight or the second query weight in response to a classification of the initial query as broad;
the method facilitates accurate ranking of query results in a search tool by adjusting the first query weight or the second query weight in response to a determination that the initial query includes at least one of: a metadata field, or a keyword; or
the method facilitates accurate ranking of query results in a search tool by adjusting the first query weight or the second query weight in response to a classification of the initial query as broad.
